(19) United States
(12) Patent Application Publication
(10) Pub. No.: US 2005/0062760 A1
(43) Pub. Date: Mar. 24, 2005

(54) Frame buffer for non-DMA display

(76) Inventor: Roger S. Twede, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/615,738

(22) Filed: Jul. 9, 2003

(51) Int. Cl. G09G 5/00

(52) U.S. Cl. 345/619

(57) ABSTRACT

A system of an embodiment of the invention is disclosed that includes a frame buffer memory for a serially addressable, non-direct memory access (DMA) display. The frame buffer memory has a number of pixels corresponding to a number of pixels of the non-DMA display. The system also includes a display data transfer circuit, to serially transfer the pixels of the frame buffer memory to the non-DMA display to update the non-DMA display.

### BACKGROUND OF THE INVENTION

Printing devices, such as laser printers and other types of printers, have become popular peripherals for computers. They have also become complex devices, with different operating characteristics and features that can used by users. For example, some laser printers that are used in office environments by a number of users allow a user to hold a print job at the printer. The printer will not actually output the print job until the user enters in a secret code. This enables the user to maintain the secrecy of the print job, so that other users cannot see what the user has printed.

To support these types and other types of features, printers usually have integrated, or embedded, graphical displays, by which users are able to change and select features of the printers. Originally, the displays were simple one- or two-line alphanumeric displays. The displays have since evolved into more complex graphical displays, having resolutions that approach those of desktop and laptop computers, such as half-VGA (640×240 pixels), VGA (640×480 pixels), and higher resolutions. The displays themselves may also be touch screens, allowing users to interact with the printers through the displays.

At least some embedded displays within printing devices, as well as embedded displays within other types of devices and other types of displays, are not direct-memory access (DMA) displays. DMA displays enable programs to write to the displays by directly accessing memory corresponding to the displays, without having to depend on processors. Non-DMA displays, by comparison, may rely on proprietary serial addressing communication schemes for writing to the displays that are decidedly non-standard.

As a result, the large amount of programming and other tools available for DMA displays do not work with non-DMA displays out of the box. Therefore, developers may have to expend considerable custom programming effort for their programs to communicate with the non-DMA displays, making product development costly and inconvenient. Furthermore, the communication schemes for writing to the displays may make for slower refreshing of their contents, and may require utilization of processors to perform the writing to the displays.

### SUMMARY OF THE INVENTION

A system of an embodiment of the invention includes a frame buffer memory for a serially addressable, non-direct memory access (DMA) display. The frame buffer memory has a number of pixels corresponding to a number of pixels of the non-DMA display. The system also includes a display data transfer circuit, to serially transfer the pixels of the frame buffer memory to the non-DMA display to update the non-DMA display.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a non-direct memory access (DMA) display, in conjunction with which embodiments of the invention may be implemented.

FIG. 2 is a diagram of an example communication format by which a non-DMA display may be communicated with, in conjunction with which embodiments of the invention may be implemented.

FIG. 3 is a diagram of a system including a non-DMA display and a frame buffer for the non-DMA display, according to an embodiment of the invention.

FIG. 4 is a diagram illustrating an approach for serially transferring the contents of a frame buffer to a non-DMA display, according to an embodiment of the invention.

FIG. 5 is a diagram of a scenario of a frame buffer in which a number of pixels have been changed and a number of pixels have not been changed, in conjunction with various approaches for sending the changed contents of the frame buffer to a non-DMA display, according to varying embodiments of the invention, are described.

FIG. 6 is a diagram of a system including a non-DMA display and two frame buffers, according to an embodiment of the invention.

FIG. 7 is a diagram of a system including a non-DMA display, a frame buffer for the non-DMA display, and a mask for the frame buffer, according to an embodiment of the invention.

FIG. 8 is a block diagram of a printing device having a non-DMA display and a frame buffer for the non-DMA display, according to an embodiment of the invention.

FIG. 9 is a flowchart of a method for serially transferring the changed pixels of a frame buffer to a non-DMA display, according to an embodiment of the invention.

FIG. 10 is a flowchart of a method for serially transferring a changed pixel of a frame buffer to a non-DMA display in accordance with the communication format of FIG. 2, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Non-DMA Display and Communication Format

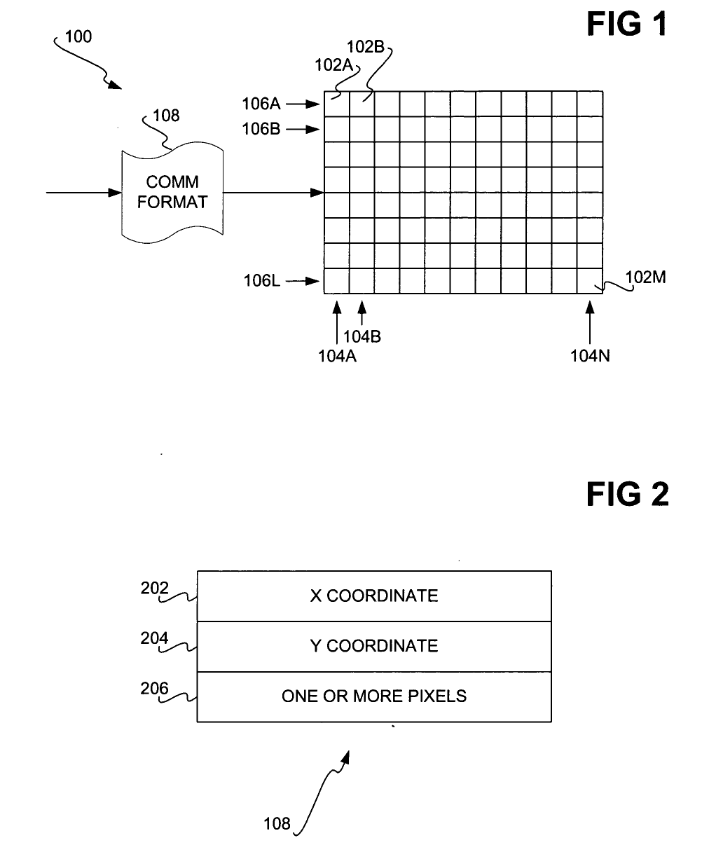

FIG. 1 shows a representative non-direct memory access (DMA) display 100, in conjunction with which embodiments of the invention may be practiced. The non-DMA display 100 is not directly memory accessible, which means that programs and components wishing to write to the display 100 cannot simply access memory that corresponds to the display 100. Rather, they communicate with the display 100 through a communication format 108, and thus may have to employ a processor to communicate with the display 100. The display 100 is thus a serially addressed display, such that data according to the communication format 108 is serially transferred to the display 100 in order to write to the display 100. The display 100 may be an embedded display or a stand-alone display.

The non-DMA display 100 has a number of pixels 102A, 102B, . . . , 102M, collectively referred to as the pixels 102. The pixels 102 may be color or black-and-white pixels. The display 100 may have a bit depth of one or more bits, such that each color component of each of the pixels 102 is represented by this number of bits. For instance, where the display 100 is a black-and-white display, there is a single color component, black. If the display 100 has a bit depth of two bits, each of the pixels 102 is represented by two bits, such that each of the pixels 102 can have a value of 0, 1, 2, or 3, where larger numbers indicate darker displayed pixels.

The pixels 102 are organized along columns 104A, 104B, . . . , 104N, collectively referred to as the columns 104, and along rows 106A, 106B, . . . , 106L, collectively referred to as the rows 106. The location of the pixel 102A specified by the column 104A and the row 106A is the origin point of the non-DMA display 100. The resolution of the display 100 is the number of the pixels 102, typically specified as the number of columns by the number of rows. The resolution of the display 100 is thus N×L, where the value of N may be greater than, less than, or equal to the value of L. For example, the resolution of the display 100 may be half-VGA, or 640×240, indicating that there are 640×240=153,600 of the pixels 102.

FIG. 2 shows an example of the communication format 108 by which the non-DMA display 100 is communicated with, in conjunction with which embodiments of the invention may be practiced. The communication format 108 specifies an x coordinate 202, a y coordinate 204, and one or more pixels 206 to be written to the display 100. The x coordinate 202 and the y coordinate 204 indicate the column of the columns 104 and the row of the rows 106, respectively, at which the pixels 206 are to be written.

The number of bits of the x coordinate 202 and of the y coordinate 204 depends on the values of N and L, respectively, where the resolution of the display 100 is N×L. For instance, if N is 640, then at least ten bits are needed to represent the x coordinate 202, because 2\hat{ }9=512 and 2\hat{ }10=1024, and 512<640<1024. If L is 240, then at least eight bits are needed to represent the y coordinate 204, because 2\hat{ }7=128 and 2\hat{ }8=256, and 128<240<256. The number of bits of each of the pixels 206 depends on the bit depth of the non-DMA display 100. If the bit depth is two bits, for example, the pixels 206 are each represented by two bits.

The first of the pixels 206 is written to the non-DMA display 100 at the location specified by the x coordinate 202 and the y coordinate 204. Subsequent of the pixels 206 are then written to the display 100 at increasingly adjacent columns in the same row. That is, the y coordinate 204 is maintained while the x coordinate 202 is increased. Once the last column within the display 100 has been reached, then the next of the pixels 206 are written to the display 100 starting at the first column of the next row. That is, the y coordinate 204 is increased, and the x coordinate 202 begins again at one. Subsequent of the pixels 206 are written to increasingly adjacent columns in this new row. This process continues until all of the pixels 206 have been written to the display 100.

For example, data according to the communication format 108 for writing to the non-DMA display 100 may have a value of one for the x coordinate 202 and a value of one for the y coordinate 204, and may specify ten pixels as the pixels 206. The first pixel is written to the display 100 at the first column 104A and at the first row 106A, whereas the next pixel is written at the second column 104B and still at the first row 106A, and so on. If there are only eight of the columns 104, then the last two pixels are written to the first and the second columns 104A and 104B of the second row 106B.

Data sent in accordance with the communication format 108 by which the non-DMA display 100 is communicated with may have to be sent in a serial manner, depending on whether the display 100 is serially addressable. This means that first the x coordinate 202 is sent bit by bit, then the y coordinate 204 is sent bit by bit, and finally each of the one or more pixels 206 is sent bit by bit. Therefore, it can be more efficient to write three contiguous pixels to the display 100 rather than write two non-contiguous pixels to the display 100. For three contiguous pixels within the same row, only one x coordinate and one y coordinate has to be specified, whereas for two non-contiguous pixels, the x coordinate and the y coordinate for each pixel has to be specified. Other communications format may also be used in alternative embodiments of the invention. For instance, the communication format 108 may be extended with a flag, such as a bit, which specifies whether the one or more pixels 206 are horizontally adjacent or vertically adjacent pixels.

Frame Buffer for Non-DMA Display

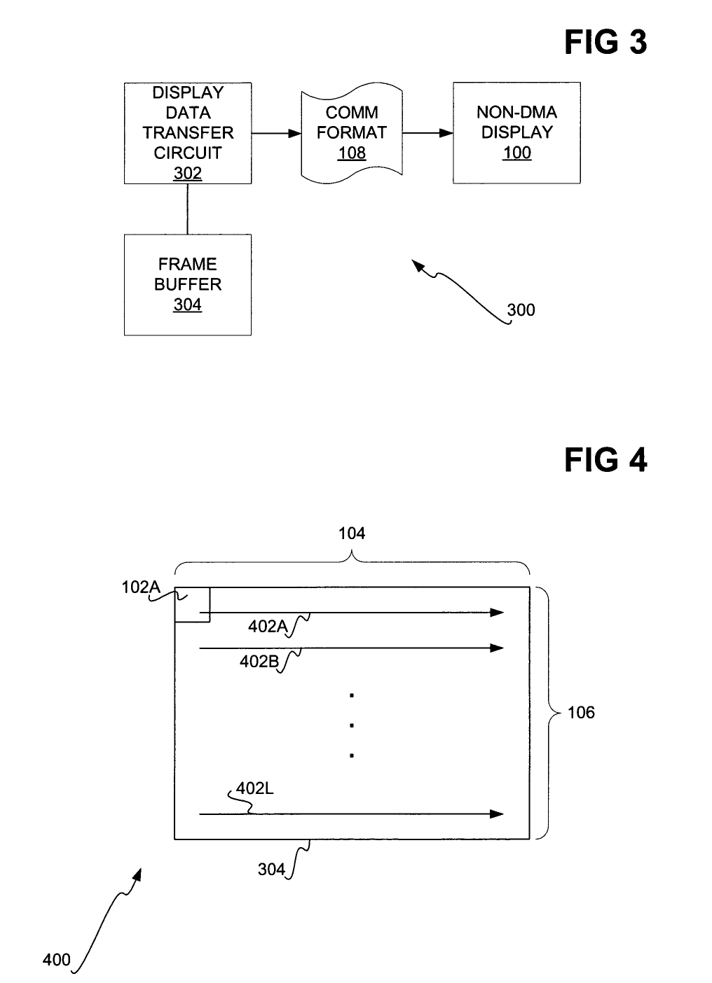

FIG. 3 shows a system 300, according to an embodiment of the invention. The system 300 includes the non-direct memory access (DMA) display 100 that is communicated with via the communication format 108, a display data transfer circuit 302, and a frame buffer 304. The frame buffer 304 is for the non-DMA display 100. The frame buffer 304 may be separate from or part of the display data transfer circuit 302. The display data transfer circuit 302 serially transfers contents of the frame buffer to the non-DMA display 100, and may be software, hardware, or a combination of software and hardware. The frame buffer 304 may support an endianness selector for byte swapping, a bit directional selection capability for bit-shift ordering, and/or other features, as can be appreciated by those of ordinary skill within the art.

The frame buffer 304 is specifically a frame buffer memory that corresponds to the resolution and bit depth of the non-DMA display 100. That is, the size of the memory of the frame buffer 304 is such that the frame buffer 304 itself has a resolution and a bit depth equal to that of the display 100. The frame buffer 304 thus has a number of pixels equal to the number of the pixels 102 of the display 100. Components and programs desiring to write to the non-DMA display 100 write directly to the frame buffer 304, as if the frame buffer 304 provided DMA to the display 100.

The display data transfer circuit 302 is responsible for conveying the contents, or pixels, of the frame buffer 304 to the non-DMA display 100, by serially transferring the contents of the frame buffer 304 to the display 100. That is, the display data transfer circuit 302 determines the contents of the frame buffer 304, and serially transfers the contents of the frame buffer 304 to the display 100 by employing the communication format 108. The components and programs are able to write to the display 100 without having to specifically avail themselves of the communication format 108, but rather can write to the frame buffer 304 in a DMA manner.

FIG. 4 illustratively depicts an approach 400 by which the display data transfer circuit 302 serially transfers the contents of the frame buffer 304 to the display 100, according to an embodiment of the invention. The frame buffer 304 is shown in FIG. 4 as having the same columns 104 and rows 106 as the display 100 does. Starting at the pixel 102A that represents the origin point of the frame buffer 304, the display data transfer circuit 302 transfers the contents of the frame buffer 304 on a pixel-by-pixel basis by columns and by rows. That is, the display data transfer circuit 302 serially transfers the contents of the first row of the frame buffer 304 on a pixel-by-pixel basis, as indicated by the arrow 402A, then serially transfers the contents of the second row of the frame buffer 304 on the same basis, as indicated by the arrow 402B, and so on, until the display data transfer circuit 302 serially transfers the contents of the last row of the frame buffer 304, as indicated by the arrow 402L. Once the display data transfer circuit 302 has reached the last column of the last row, it repeats this process.

As the contents of the frame buffer 304 are changed by programs and components, they will ultimately be sent to the non-DMA display 100 by the display data transfer circuit 302, when the display data transfer circuit 302 reaches the row and the column at which a given change has occurred. That is, the display data transfer circuit 302 can be considered in this embodiment as scanning the frame buffer 304 column-by-column, and row-by-row. Each pixel of the frame buffer 304 is serially transferred by the display data transfer circuit 302 to the display 100, via the communication format 108.

Where serial communications with the non-DMA display 100 are relatively slow, improvements on the basic approach 400 of FIG. 4 can be made so that the contents of the frame buffer 304 are sent by the display data transfer circuit 302 to the display 100 as the contents are changed. Pixels of the frame buffer 304 that remain unchanged, in other words, are not sent to the display 100. Thus, the display data transfer circuit 302 monitors the frame buffer 304, and serially transfers the contents of the frame buffer 304 that have changed to the display 100, and not necessarily the contents of the frame buffer 304 that have not changed.

FIG. 5 shows an example scenario 500 of the frame buffer 304, in conjunction with which various approaches to serially transfer the contents of the frame buffer 304 that have changed to the non-DMA display 100 are described, according to varying embodiments of the invention. The frame buffer 304 has several highlighted pixels 502, 504, 506, 508, 510, 512, and 514 that for the sake of descriptive purposes have been changed by programs or components. That a pixel of the frame buffer 304 has changed means that the value of the pixel has changed from what it was since the last serial transfer of that pixel. There are also non-highlighted pixels 516 and 518 that have not changed. The pixel 516 is between the pixels 502 and 504, whereas the pixel 518 is between the pixels 504 and 506. The pixels 506 and 508 are adjacent to one another, whereas the pixels 510, 512, and 514 are also part of an adjacent group of pixels.

In one approach, the display data transfer circuit 302 monitors the contents of the frame buffer 304, and as changes are made thereto, serially transfers the changed contents to the non-DMA display 100, on a pixel-by-pixel basis, utilizing the communication format 108. Thus, in the example scenario 500, the display data transfer circuit 302 first sends the pixel 502, then the pixel 504, the pixel 506, the pixel 508, the pixel 510, the pixel 512, and the pixel 514, to the display 100. For instance, for the pixel 502, the display data transfer circuit 302 specifies the x and the y coordinates of the pixel 502, and then sends the new value for the pixel 502. More generally, for each changed pixel, the display data transfer circuit 302 in this approach specifies the x and the y coordinates for the pixel and the new value for the pixel.

In another approach, the display data transfer circuit 302 still monitors the contents of the frame buffer 304, but as changes are made thereto, serially transfers the changed contents to the non-DMA display 100 by groups of one or more sequential pixels that have changed, utilizing the communication format 108. A group of changed pixels are sequential to one another where the sequence of such pixels represents a sequence of immediately adjacent changed pixels, without any intervening unchanged pixels. For instance, pixels in the fourth, fifth, and sixth columns of a given row are part of the same sequential pixel group, whereas pixels in the fifth, sixth, and eighth columns of a given row are not part of the same sequential pixel group. This is because the former pixels represent a sequence of immediately adjacently pixels, whereas the latter pixels do not, since there is an intervening pixel in the seventh column. Furthermore, a pixel in the last column of a row is considered to be part of the same sequential pixel group as is a pixel in the first column of the immediately next row.

In the scenario 500, there are four sequential pixel groups: a first group encompassing the single pixel 502, a second group encompassing the single pixel 504, a third group encompassing the pixels 506 and 508, and a fourth group encompassing the pixels 510, 512, and 514. The display data transfer circuit 302 sends each sequential pixel group to the non-DMA display 100 by utilizing the communication format 108, specifically specifying the x and the y coordinates of just the first pixel within each group. For instance, for the third sequential pixel group, the display data transfer circuit 302 specifies the x and the y coordinates of the pixel 506, and then sends the values for both the pixel 506 and the pixel 508. That is, the display data transfer circuit 302 does not send the x and the y coordinates of the pixel 508, since this pixel is immediately adjacent and sequential to the pixel 506.

Similarly, for the fourth sequential pixel group, the display data transfer circuit 302 specifies the x and the y coordinates of the pixel 510, and then sends the values for the pixels 510, 512, and 514 to the non-DMA display 100 via the communication format 108. The display data transfer circuit 302 does not have to send the x and the y coordinates of the pixels 512 and 514. In this approach, then, the display data transfer circuit 302 effectively minimizes the amount of data transfer needed to convey the changed pixels of the third and the fourth sequential pixel groups, because it sends the x and the y coordinates for just the first pixel of each group. Minimizing the amount of data transfer needed to convey changed pixels of the frame buffer 304 to the display 100 can increase the performance of the system 300.

In a third approach, the display data transfer circuit 302 again monitors the contents of the frame buffer 304, but as changes are made thereto, serially transfers the changed contents to the non-DMA display 100 by groups of one or more pixels that are inclusive of the pixels that have changed, but that also may include pixels that have not changed, utilizing the communication format 108. More specifically, the display data transfer circuit 302 determines these groups of sequential pixels with the goal of minimizing the amount of data transfer needed to convey the changed pixels within the frame buffer 304 to the display 100, by including unchanged pixels within the group as appropriate. The display data transfer circuit 302 again utilizes the communication format 108 in serially transferring the sequential pixel groups.

For example, in the scenario 500, based on the number of bits needed to send the x and the y coordinates of a pixel's location and on the number of bits needed to send the data of a pixel's value, it may be more efficient to send one sequential pixel group including the pixels 502, 516, 504, 518, 506, and 508. That is, the display data transfer circuit 302 may determine that it is more efficient to send this one sequential pixel group, instead of three sequential pixel groups, a first group including the pixel 502, a second group including the pixel 504, and a third group including the pixels 506 and 508. This is because the added data in sending the values of the pixels 516 and 518 may be less than the data in sending the x and the y coordinates of the pixel 504 in the second pixel group and of the pixel 506 in the third pixel group.

More specifically, each pixel may be represented by two bits, the x coordinate may be represented by ten bits, and the y coordinate may be represented by eight bits. To send just the changed pixels 502, 504, 506, and 508 as three separate sequential pixel groups to the non-DMA display 100 requires sixty-two bits. For the first group including just the pixel 502, twenty bits are required: eighteen bits to send the x and the y coordinates for the pixel 502, and two bits to send the new value of the pixel 502. For the second group including just the pixel 504, twenty bits are similarly needed. For the third group including the pixels 506 and 508, twenty-two bits are needed: eighteen bits to send the x and the y coordinates for the pixel 506, two bits to send the new value of the pixel 506, and two bits to send the new value of the pixel 508.

By comparison, to send the changed pixels 502, 504, 506, and 508 as part of a single sequential pixel group including the unchanged pixels 516 and 518, only thirty bits are needed. The x and the y coordinates for the pixel 502 account for eighteen bits. Because there are six pixels in the group, the values for the pixels account for twelve bits. Thus, by sending one sequential pixel group to the non-DMA display 100 that includes some unchanged pixels in addition to changed pixels, instead of sending three sequential pixel groups that only include changed pixels, the display data transfer circuit 302 reduces the amount of data that needs to be transferred to the display 100. Where communications with the display 100 are relatively slow, this can noticeably increase the performance of the system 300.

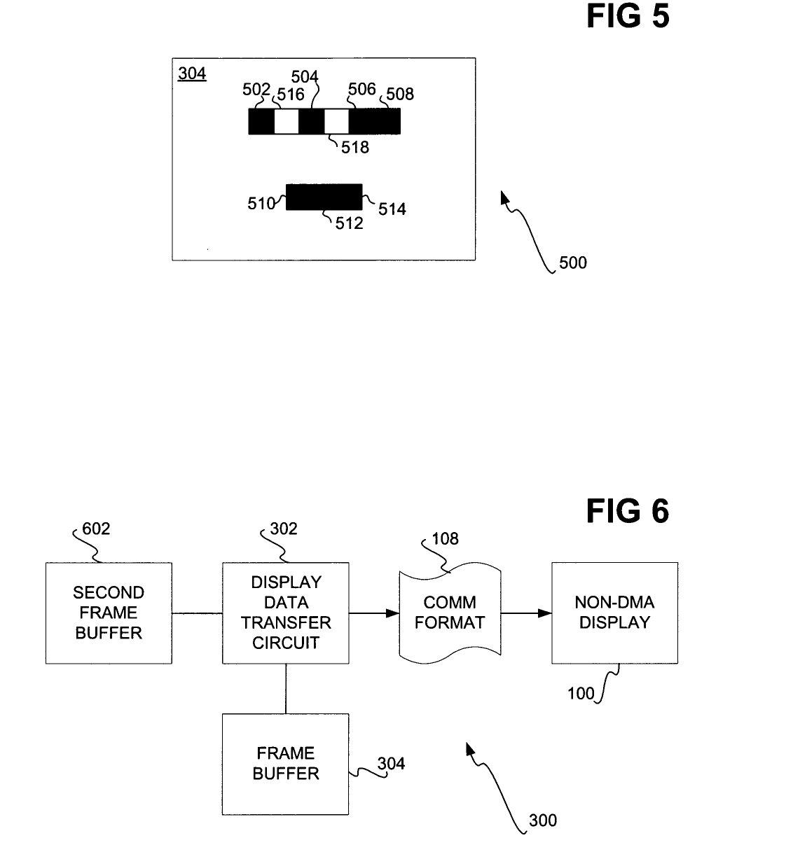

FIG. 6 shows the system 300 as also including a second frame buffer 602 by which the display data transfer circuit 302 is able to monitor changes made to the frame buffer 304, according to an embodiment of the invention. The second frame buffer 602 has the same resolution and bit depth as does the frame buffer 304, equal to the resolution and bit depth of the non-DMA display 100. Once the display data transfer circuit 302 has initially serially transferred the contents of the frame buffer 304 to the display 100 by utilizing the communication format 108, it copies the contents of the frame buffer 304 to the contents of the second frame buffer 602.

The next time the display data transfer circuit 302 is to send changes to the frame buffer 304 to the non-DMA display 100, it locks the frame buffer 304 so that further changes cannot be made thereto, and compares the contents of the frame buffer 304 with that of the second frame buffer 602 to determine which pixels of the frame buffer 304 have changed. These pixels are sent to the display 100. The display data transfer circuit 302 copies the frame buffer 304 to the second frame buffer 602 again, and unlocks the frame buffer 304 so that new changes can be made to the contents of the frame buffer 304. This process is repeated each time the display data transfer circuit 302 sends changes to the frame buffer 304 to the display 100.

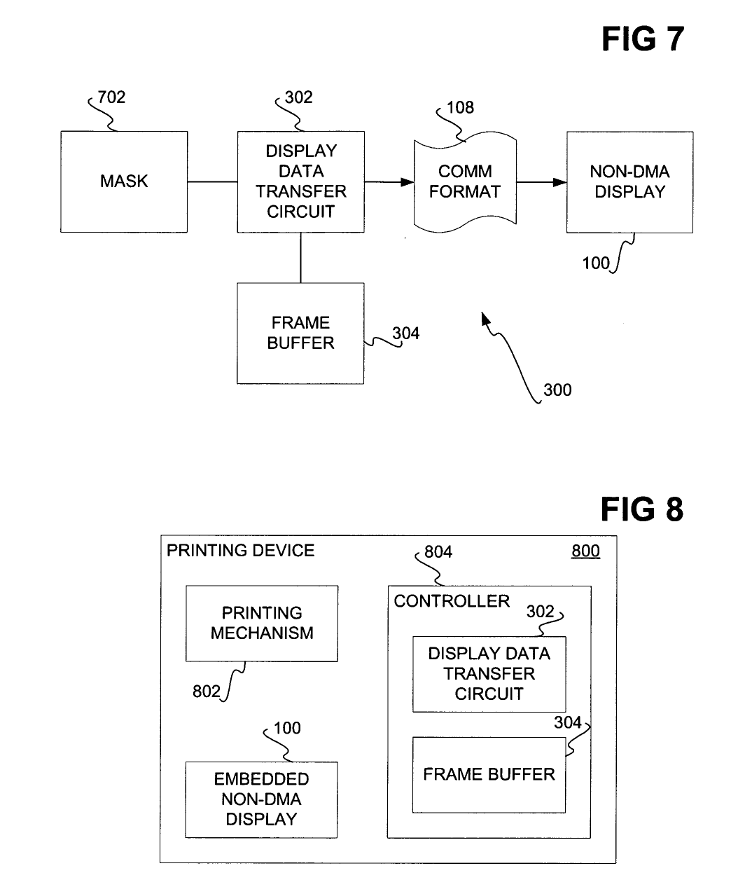

FIG. 7 shows the system 300 as including a mask 702 instead of the second frame buffer 602 for the display data transfer circuit 302 to monitor changes made to the frame buffer 302, according to an embodiment of the invention. The mask 702 has the same resolution as the frame buffer 304 and the non-DMA display 100 have, but preferably has a single bit depth. Therefore, the mask 702 has a bit that corresponds to each pixel of the frame buffer 304. Once the display data transfer circuit 302 has initially serially transferred the contents of the frame buffer 304 to the display 100 by utilizing the communication format 108, it zeros the bits of the mask 702.

When programs or components change pixels of the frame buffer 304, they preferably also change the bits of the mask 702 that correspond to these pixels to ones. The next time the display data transfer circuit 302 is to send changes to the frame buffer 304 to the non-DMA display 100, it locks the frame buffer 304 and the mask 702 so that further changes cannot be made thereto, and sends the pixels of the frame buffer 304 that correspond to bits of the mask 702 that have one values to the display 100. The display data transfer circuit 302 again zeros the mask 702, and unlocks the frame buffer 304 and the mask 702 so that new changes can be made. This process is repeated each time the display data transfer circuit 302 sends changes to the frame buffer 304 to the display 100.

Printing Device and Methods

FIG. 8 is a block diagram of a printing device 800, according to an embodiment of the invention. The device 800 may be an inkjet-printing device, a laser-printing device, or another type of printing device. The printing device 800 includes a printing mechanism 802, the non-direct memory access (DMA) display 100 that is specifically referred to as the embedded non-DMA display 100 in FIG. 8, and a controller 804. The printing mechanism 802 is the mechanism that prints images onto media. That is, the printing mechanism 802 includes those components, such as hardware, software, mechanical components, electrical components, and other components, that enable the printing device 800 to print onto media. The printing mechanism 802 may be an inkjet-printing mechanism, a laser-printing mechanism, or another type of printing mechanism. The non-DMA display 100 is referred to as the embedded non-DMA display 100 in FIG. 8 because it is a part of, or integral with, the printing device 800. The device 800 may include other components, in addition to and/or in lieu of those depicted in FIG. 8, as can be appreciated by those of ordinary skill within the art.

The controller 804 may be software, hardware, or a combination of hardware and software. For example, the controller 804 may be an application-specific integrated circuit (ASIC). The controller 804 includes the display data transfer circuit 302 and the frame buffer 304 that have been described, such that the circuit 302 may be an ASIC. The controller 804 may also include the second frame buffer 602 of FIG. 6 or the mask 700 of FIG. 7 in varying embodiments of the invention.

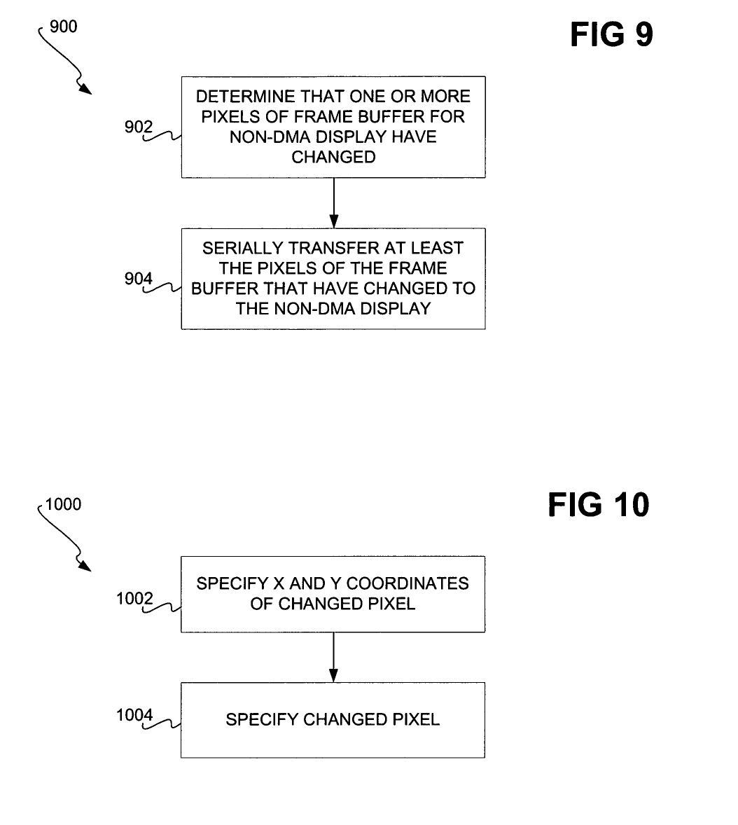

FIG. 9 shows a method 900 for transferring the changed pixels of the frame buffer 304 to the non-DMA display 100, according to an embodiment of the invention. The method 900 may be performed by the display data transfer circuit 302 in one embodiment. The method 900 may further be implemented as computer instructions stored on a computer-readable medium. The computer-readable medium may, for instance, be a solid-state or semiconductor medium, an optical medium, and/or magnetic medium.

First, the display data transfer circuit 302 determines that one or more pixels of the frame buffer 302 for the non-DMA display 100 have changed (902). The display data transfer circuit 302 may make this determination by utilizing the second frame buffer 602 as a copy of the frame buffer 302, or by utilizing the mask 702, for instance. In response to determining that one or more pixels of the frame buffer 302 have changed, the display data transfer circuit 302 serially transfers at least these pixels to the non-DMA display 100 (904). In one embodiment, the display data transfer circuit 302 accomplishes this by serially sending the changed pixels to the non-DMA display 100 on a pixel-by-pixel basis, in accordance with the communication format 108.

FIG. 10 shows a method 1000 for transferring a changed pixel of the frame buffer 304 to the non-DMA display 100 in accordance with the communication format 108 of the embodiment of FIG. 2, according to an embodiment of the invention. The method 1000 may also be performed by the display data transfer circuit 302, and may be implemented as computer instructions stored on a computer-readable medium. First, the x and the y coordinates of the changed pixel are specified, or sent to the display 100 (1002). Next, the value of the changed pixel itself is specified, or sent to the display 100 (1004).

In another embodiment of the invention, the display data transfer circuit 302 accomplishes serially transferring the changed pixels of the frame buffer to the non-DMA display 100 in 904 of the method 900 of FIG. 9 by determining one or more sequential pixel groups that are inclusive of the changed pixels that minimize data transfer to the display 100. As has been described in the preceding section of the detailed description, the sequential pixel groups may each only include changed pixels, or some of the groups may also include unchanged pixels, where including unchanged pixels within some groups minimizes data transfer to the display 100.

Once the sequential pixel groups have been determined, the display data transfer circuit 302 performs the method 1000 of FIG. 10 for each pixel group, instead of for each changed pixel. Thus, in 1002, the x and the y coordinates of the first pixel in a pixel group are specified. In 1004, the pixels of the pixel group are specified, instead of specifying just a single changed pixel.

### CONCLUSION

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. For instance, whereas an embodiment of the invention has been described in relation to a non-direct memory access (DMA) display embedded within a printing device, other embodiments of the invention are applicable to displays that are not embedded within printing devices. Therefore, it is manifestly intended that this invention be limited only by the claims and equivalents thereof.

1. A system comprising:
a frame buffer memory for a serially addressable, non-direct memory access (DMA) display, the frame buffer memory having a number of pixels corresponding to a number of pixels of the non-DMA display; and,
a display data transfer circuit to serially transfer the pixels of the frame buffer memory to the non-DMA display to update the non-DMA display.

2. The system of claim 1, further comprising the non-DMA display.

3. The system of claim 1, wherein the non-DMA display is communicated with via a communication format comprising:
an x coordinate of the display;
a y coordinate of the display; and,
a number of sequential pixels to be written to the display starting at the x coordinate and at the y coordinate.

4. The system of claim 1, wherein the non-DMA display is one of a stand-alone display and an embedded display.

5. The system of claim 1, wherein the frame buffer memory is separate from the display data transfer circuit.

6. The system of claim 1, wherein the frame buffer memory is part of the display data transfer circuit.

7. The system of claim 1, wherein the data transfer circuit is an application-specific integration circuit (ASIC).

8. The system of claim 1, wherein the frame buffer memory has a bit depth of at least one bit corresponding to a bit depth of the display.

9. The system of claim 1, wherein the display data transfer circuit is to start at an origin point of the display when serially transferring the pixels of the frame buffer memory to the display.

10. The system of claim 1, wherein the display data transfer circuit is to monitor changes made to the pixels of the frame buffer memory, and is to serially transfer the pixels of the frame buffer memory that have changed to the display.

11. The system of claim 10, wherein the display data transfer circuit is to serially transfer the pixels of the frame buffer memory that have changed to the display by determining a number of sequential pixel groups inclusive of one or more of the pixels of the frame buffer memory that have changed that minimize data transfer to the display.

12. The system of claim 11, wherein at least one of the sequential pixel groups are also inclusive of one or more of the pixels of the frame buffer memory that remain unchanged.

13. The system of claim 10, wherein the frame buffer memory is a first frame buffer memory, the system further comprising a second frame buffer memory to which the pixels of the first frame buffer memory are copied, the display data transfer circuit to compare pixels of the second frame buffer memory against the pixels of the first frame buffer memory to determine whether changes have been made to the pixels of the first frame buffer memory.

14. The system of claim 10, further comprising a mask to indicate that changes have been made to the pixels of the frame buffer memory.

15. The system of claim 1, wherein the frame buffer memory supports at least one of an endianness selector and a bit directional selection capability.

16. A system comprising:
a frame buffer memory for a serially addressable, non-direct memory access (DMA) display, the frame buffer memory having a number of pixels corresponding to a number of pixels of the non-DMA display; and,
means for serially transferring the pixels of the frame buffer memory to the non-DMA display to update the non-DMA display.

17. The system of claim 16, further comprising the non-DMA display.

18. The system of claim 16, wherein the non-DMA display is communicated with via a communication format comprising:
an x coordinate of the display;
a y coordinate of the display; and,
a number of sequential pixels to be written to the display starting at the x coordinate and at the y coordinate.

19. The system of claim 16, wherein the means is further for monitoring changes made to the pixels of the frame buffer memory, and for serially transferring the pixels of the frame buffer memory that have changed to the non-DMA display as a series of pixel groups.

20. The system of claim 19, wherein each pixel group includes one or more sequential pixels of the frame buffer memory that have changed.

21. The system of claim 19, wherein each pixel group includes a sequence of at least one pixel, the sequence of at least one pixel group including one or more of the pixels of the frame buffer memory that remain unchanged.

22. A method comprising:
determining that one or more pixels of a frame buffer memory for a serially addressable, non-direct memory access (DMA) display have changed; and,
in response to determining that the one or more pixels of the frame buffer memory have changed, serially transferring at least the one or more pixels from the frame buffer memory to the display.

23. The method of claim 22, wherein determining that the one or more pixels of the frame buffer memory have changed comprises comparing the frame buffer memory to a previously made copy of the frame buffer memory to determine whether one or more pixels of the frame buffer memory have changed.

24. The method of claim 22, wherein determining that the one or more pixels of the frame buffer memory have changed comprises utilizing a mask indicating that the one or more pixels have changed.

25. The method of claim 22, wherein serially transferring at least the one or more pixels from the frame buffer memory to the display comprises, for each pixel of the one or more pixels,
specifying to the display an x coordinate and a y coordinate of the pixel; and,
specifying the pixel to the display.

26. The method of claim 22, wherein serially transferring at least the one or more pixels from the frame buffer memory to the display comprises determining a number of sequential pixel groups inclusive of at least the one or more pixels that minimize data transfer to the display.

27. The method of claim 26, wherein determining the number of sequential pixel groups comprises determining at least one pixel group that is also inclusive of one or more pixels of the frame buffer memory that remain unchanged.

28. The method of claim 26, wherein serially transferring at least the one or more pixels from the frame buffer memory to the display further comprises, for each sequential pixel group,
specifying to the display an x coordinate and a y coordinate at which the sequential pixel group starts; and,
specifying to the display a number of bits corresponding to the sequential pixel group.

29. A printing device comprising:
a printing mechanism by which the printing device is able to print images onto media;
an embedded serially addressable, non-direct memory access (DMA) display by which a user is able to monitor the printing mechanism and change characteristics of the printing mechanism;
a frame buffer memory for the embedded display, the frame buffer memory having a number of pixels corresponding to a number of pixels of the embedded display; and,
a display data transfer circuit to serially transfer the pixels of the frame buffer memory to the embedded display to update the embedded display.

30. The device of claim 29, wherein the embedded display is communicated with via a communication format comprising:
an x coordinate of the display;
a y coordinate of the display; and,
a number of sequential pixels to be written to the display starting at the x coordinate and at the y coordinate.

31. The device of claim 29, wherein the display data transfer circuit is to serially transfer the pixels of the frame buffer memory to the display by monitoring changes made to the pixels of the frame buffer memory and serially transferring the pixels of the frame buffer memory that have changed to the display.

32. The device of claim 29, wherein the display data transfer circuit is to serially transfer the pixels of the frame buffer memory to the display by determining a number of sequential pixel groups inclusive of one or more pixels of the frame buffer memory that have changed that minimize data transfer to the display.

33. The device of claim 29, wherein the printing mechanism is one of a laser-printing mechanism and an inkjet-printing mechanism, such that the printing device is one of a laser-printing device and an inkjet-printing device.
